(19) United States
(12) Patent Application Publication
(10) Pub. No.: US 2005/0105895 A1
(43) Pub. Date: May 19, 2005

(54) METHOD FOR AUDIO/VIDEO ENCODING/DECODING IN A SINGLE CHIP ELECTRONIC CIRCUIT

(76) Inventor: Chi-Cheng Ju, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,474

(22) Filed: Nov. 12, 2004

(30) Foreign Application Priority Data
Nov. 14, 2003 (TW) 092131897

(51) Int. Cl. H04N 5/76; H04L 12/16; H04Q 11/00

(52) U.S. Cl. 386/96; 386/98

(57) ABSTRACT

A method for audio/video decoding uses a single chip electronic circuit including an optical storage read/write controller circuit and an audio/video codec circuit. The method includes (a) controlling the read operation of an error correction code (ECC) from an optical disk by the optical storage read/write controller circuit, processing the ECC block to obtain at least one data sector, and storing the data sector into the memory, (b) reading the data sector from the memory by the optical storage read/write controller circuit to obtain at least one piece of main data, transmitting the main data to the audio/video codec circuit where the main data is separated into audio and video streams and stored into the memory, and (c) reading the separated audio and video data from the memory by the audio/video codec circuit to perform audio/video decoding, and storing the decoded audio and video data into the memory.

### BACKGROUND

The invention relates to a method for audio/video encoding/decoding in a single chip electronic circuit, and more particularly, to a method for audio/video encoding/decoding in a single chip electronic circuit composed of an optical storage read/write controller circuit and audio/video codec circuit.

The digital versatile disk (DVD) is a sort of storage media having high capacity in the range of gigabytes. One of its purposes is to store MPEG (moving picture expert group) files.

In contrast to the earlier video home system (VHS) or video compact disk (VCD), the DVD is better in quality. Moreover, typical DVD recorders can also play VCD. Thus DVD recorders are replacing VHS recorders and VCD recorders day by day.

Please refer to FIG. 1 showing a block diagram of a conventional DVD recorder. The DVD recorder 100 reads data from an optical disk (not shown). The data is processed and separated into audio and video data. The video data is transmitted to a display device (e.g. a liquid crystal display (LCD), not shown), and the audio data is transmitted to a sound device (e.g. a speaker, not shown). The DVD recorder 100 can also receive audio data and video data separately and then process them for storage onto the optical disk. Please note that the optical disk can be a DVD or a CD, or even read-only or rewritable disks such as CD-R, CD-RW, DVD+R, DVD+RW, DVD-R, DVD-RW, DVD-RAM. The DVD recorder 100 is composed of three parts, which are a disk loader mechanism 110, an optical storage read/write controller circuit 120, and an audio/video codec circuit 140. The optical storage read/write controller circuit 120 operates servo control on the disk loader mechanism 110 as well as encoding/decoding error correction code (ECC). The audio/video codec circuit 140 performs audio/video encoding/decoding in accordance with a specific standard (e.g. MPEG).

The optical storage read/write controller circuit 120 and the audio/video codec circuit 140 are on two different chips having their own memory controllers as well as their own memory 150, 160. The transmission between the two different chips depends on a bus 130 shown in the figure. The bus 130 can be a standard ATAPI/IDE bus or a proprietary A/V bus.

Since memories account for a larger percentage of the cost of the whole system, the present invention integrates the optical storage read/write controller circuit and the audio/video codec circuit into a single chip electronic circuit. The single chip electronic circuit uses only one memory without the bus 130 and its two bus interfaces 126, 146 as shown in FIG. 1. Thus, the cost can be reduced.

However, the single chip electronic circuit requires a proper method for audio/video encoding/decoding, or the performance of the whole system cannot be obviously improved. Therefore, the present invention also provides a method for audio/video encoding/decoding especially for a single chip electronic circuit.

### SUMMARY OF INVENTION

It is therefore an objective of the claimed invention to provide a method for audio/video encoding/decoding in a single chip electronic circuit, in order to improve the performance on audio/video encoding/decoding. The single chip electronic circuit includes an optical storage read/write controller circuit for servo control and encoding/decoding ECC and an audio/video codec circuit for audio/video encoding/decoding. Both use the same memory.

Briefly, the present invention provides a method for audio/video decoding using the above-mentioned single chip electronic circuit. The method includes (a) controlling the read operation of an error correction code (ECC) block from an optical disk by the optical storage read/write controller circuit, processing the ECC block to obtain at least one data sector, and storing the data sector into the memory, (b) reading the data sector from the memory by the optical storage read/write controller circuit to obtain at least one piece of main data, transmitting the main data to the audio/video codec circuit, separating the main data into audio and video streams by the audio/video codec circuit and storing the separated audio and video data into the memory, and (c) reading the separated audio and video data from the memory by the audio/video codec circuit to perform audio/video decoding and storing the decoded audio and video data into the memory.

The present invention also provides a method for audio/video decoding using the single chip electronic circuit. The method includes (a) controlling the read operation of an ECC block from an optical disk by the optical storage read/write controller circuit, performing PO decoding to the ECC block, and storing a processed data into the memory, (b) reading the processed data from the memory by the optical storage read/write controller circuit, performing PI decoding to obtain at least one data sector, processing the data sector to obtain at least one piece of main data and transmitting the main data to the audio/video codec circuit, and separating the main data into audio and video streams by the audio/video codec circuit and storing the separated audio and video data into the memory, and (c) reading the separated audio and video data from the memory by the audio/video codec circuit to perform audio/video decoding and storing the decoded audio and video data into the memory.

The present invention also provides a method for audio/video encoding using the single chip electronic circuit. The method includes (a) receiving an audio and video data by the audio/video codec circuit to perform audio/video encoding and storing an encoded audio and video data into the memory, (b) reading the encoded audio and video data from the memory by the audio/video codec circuit to multiplex the encoded audio and video bit streams in order to obtain at least one piece of main data, transmitting the main data to the optical storage read/write controller circuit, processing the main data by the optical storage read/write controller circuit to obtain at least one data sector and storing the data sector into the memory, and (c) reading the data sector from the memory by the optical storage read/write controller circuit, processing the data sector to obtain an ECC block, and writing the ECC block in an optical disk.

The present invention also provides a method for audio/video encoding using the single chip electronic circuit. The method includes (a) receiving an audio and video data by the audio/video codec circuit to perform audio/video encoding and storing an encoded audio and video data into the memory, (b) reading the encoded audio and video data from the memory by the audio/video codec circuit to multiplex the encoded audio and video data in order to obtain at least one piece of main data, transmitting the main data to the optical storage read/write controller circuit, processing the main data by the optical storage read/write controller circuit to obtain at least one data sector, performing PI encoding to the data sector, and storing a processed data into the memory, and (c) reading the processed data from the memory by the optical storage read/write controller circuit, performing uncompleted ECC encoding to obtain an ECC block, and writing the ECC block in an optical disk.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional DVD recorder.

FIG. 2 is a block diagram of a DVD recorder having a single chip electronic circuit according to the present invention.

FIG. 3 illustrates data configuration of a data sector according to the DVD specification.

FIG. 4 illustrates data configuration of an ECC block according to the DVD specification.

FIG. 5 is a flowchart of the method for audio/video decoding according to the first embodiment of the present invention.

FIG. 6 is a flowchart of the method for audio/video decoding according to the second embodiment of the present invention.

FIG. 7 is a flowchart of the method for audio/video encoding according to the first embodiment of the present invention.

FIG. 8 is a flowchart of the method for audio/video encoding according to the second embodiment of the present invention.

### DETAILED DESCRIPTION

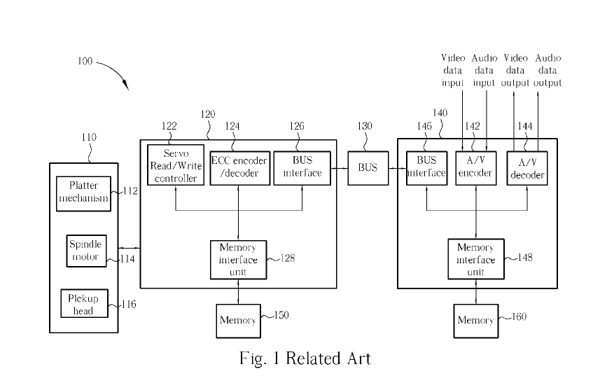

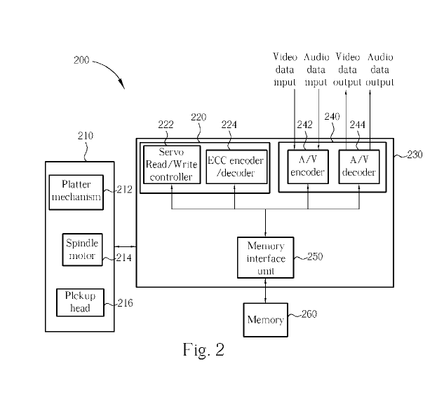

Please refer to FIG. 2 showing a block diagram of a DVD recorder having a single chip electronic circuit according to the present invention. The DVD recorder 200 includes a disk loader mechanism 210, the single chip electronic circuit 230, and a memory 260. The single chip electronic circuit 230 is composed of two parts, which are an optical storage read/write controller circuit 220 and an audio/video codec circuit 240, both using the same memory 260. Obviously, the hardware architecture in FIG. 2 has lower hardware cost than the conventional one in FIG. 1. Please notice that the audio/video codec circuit 240 performs audio/video encoding/decoding in accordance with but not limited to some kind of standards such as the MPEG standard.

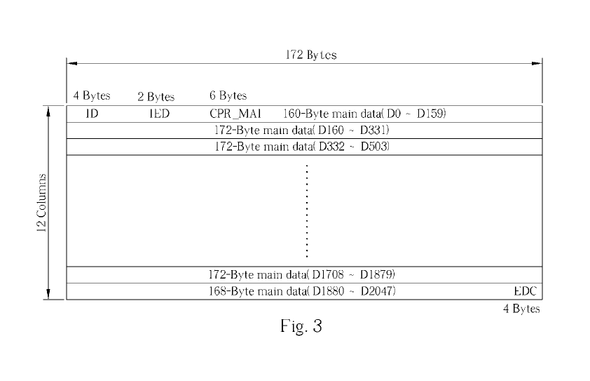

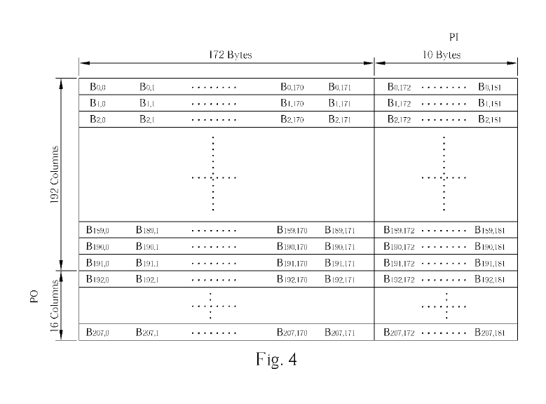

The data format of DVD regulated in DVD specification for read-only memory (part 1, physical specification, version 1.0, August 1996) is hereby described in advance. Generally, when writing data into a DVD, it is required to divide the data into a plurality of 2048-byte main data and add identification data (ID), ID error correction code (IED), CPR_MAI, and error detection code (EDC) to each of the 2048-byte main data, and then scramble them to form 2064-byte (172 bytes*12 columns) data sectors shown in FIG. 3. During the writing, ECC encoding is performd every 16 data sectors, in the sequence of outer-code parity (PO) encoding and then inner-code parity (PI) encoding, to obtain an ECC block shown in FIG. 4. As for reading data, decoding is performd in opposite flow of the encoding described above. The encoding/decoding is performd by an ECC encoder/decoder 124, 224 in FIG. 1 and FIG. 2.

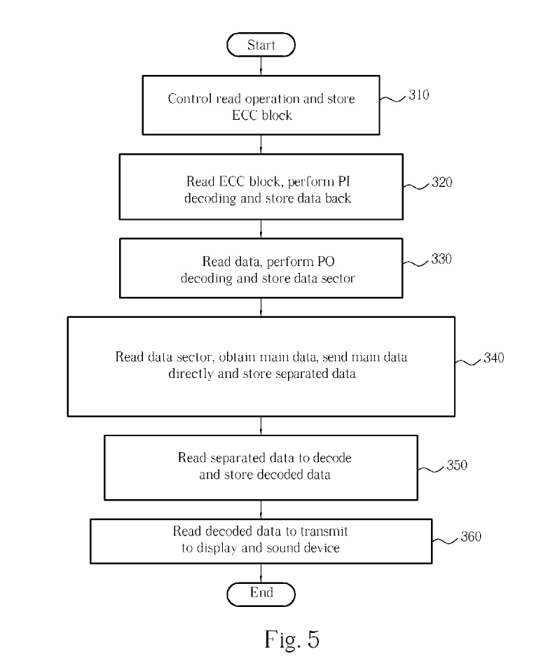

Please refer to FIG. 5 as well as FIG. 2. FIG. 5 shows a flowchart of the method for audio/video decoding according to the first embodiment of the present invention as follows:

Step310: Control the read operation of the disk loader mechanism 210 by the optical storage read/write controller circuit 220 and store a read out ECC block into the memory 260.

Step320: Read the ECC block from the memory 260 by the optical storage read/write controller circuit 220; perform PI decoding and store the result back into the memory 260.

Step330: Read the processed data from the memory 260 by the optical storage read/write controller circuit 220, perform PO decoding to obtain at least one data sector (as mentioned above, an ECC block for 16 data sectors in general), and store the data sectors back into the memory 260.

Step340: Read the data sectors from the memory 260 by the optical storage read/write controller circuit 220, descramble the data sectors and perform error detection process by EDC data to obtain at least one piece of main data (as mentioned above, a data sector for a piece of main data in general), and then transmit the main data directly to the audio/video codec circuit 240 to separate the main data into audio and video bit streams, and then store the separated audio and video data back into the memory 260.

Step350: Read the separated audio and video data from the memory 260 by the audio/video codec circuit 240 to perform audio/video decoding, and then store the decoded audio and video data back into the memory 260.

Step360: Read the decoded audio and video data from the memory 260 by the audio/video codec circuit 240 and transmit them respectively to a display device and a sound device (both are not shown in FIG. 2).

A person skilled in the art can easily find that the number of times the memory 260 is accessed is less than that in the related art. Especially in the case of Step340, the related art would require the memory to be accessed many times to accomplish the same goal (for instance, in the related art, first read the data sectors from the memory 150 by the optical storage read/write controller circuit 120 for descrambling and EDC process to obtain the main data to store back into the memory 150. Then read the main data from the memory 150 to store the data into the memory 160 through the bus interface 126, the bus 130, and the bus interface 146. Continuously read the main data from the memory 160 by the audio/video codec circuit 140 to separate the main data into audio and video bit streams and then store them back into the memory 160). On the contrary, the present invention only requires reading the data in the memory 260 in Step 340 and storing the data back into the memory 260 after processing them, without any additional memory access. Therefore, the present invention reduces the requirement on memory bandwidth of the single chip electronic circuit 230, and since the number of memory access is reduced, the performance on decoding can be improved. Please notice that any two or more steps can be integrated into one signal step (for instance, PI decoding and PO decoding in Step320 and Step330 can be integrated into one single step), in order to reduce the number of memory accesses further.

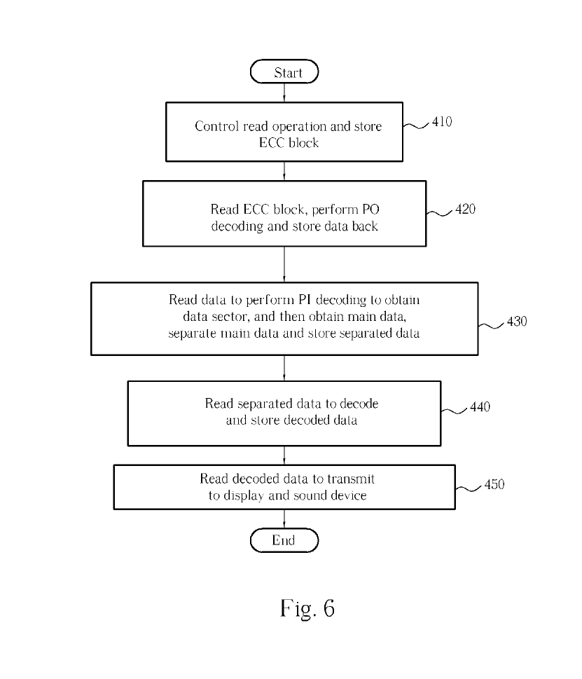

Please refer to FIG. 6 showing a flowchart of the method for audio/video decoding according to the second embodiment of the present invention as follows:

Step410: Control the read operation of the disk loader mechanism 210 by the optical storage read/write controller circuit 220 and store the read out ECC block into the memory 260.

Step420: Read the ECC block from the memory 260 by the optical storage read/write controller circuit 220, perform PO decoding, and store the result back into the memory 260.

Step430: Read the processed data from the memory 260 by the optical storage read/write controller circuit 220, perform PI decoding to obtain at least one data sector, descramble the data sector and perform error detection process by EDC data to obtain at least one piece of main data to transmit directly to the audio/video codec circuit 240, and separate the main data into audio and video bit streams by the audio/video codec circuit 240, and then store the separated audio and video data back into the memory 260.

Step440: Read the separated audio and video data from the memory 260 by the audio/video codec circuit 240 to perform audio/video decoding, and then store the decoded audio and video data back into the memory 260.

Step450: Read the decoded audio and video data from the memory 260 by the audio/video codec circuit 240 and transmit them respectively to a display device and a sound device.

The method in FIG. 6 has the same advantages as the method in FIG. 5. The main technical feature of FIG. 6 is that during ECC decoding, the related art performs PI decoding (i.e. perform PI error correction to both 16 data sectors and PO code) in advance of PO decoding (i.e. perform PO error correction again to 16 data sectors), while the second embodiment of the present invention performs PO decoding (i.e. perform PO error correction to 16 data sectors) in advance of PI decoding (i.e. perform PI error correction again to 16 data sectors). Although the PI error correction of PO code is not performd in the second embodiment, the number of memory accesses is reduced further. Therefore, compared by the method according to the first embodiment, the method according to the second embodiment further reduces the requirement on memory bandwidth of the single chip electronic circuit 230 and hence, improves the performance of the whole system.

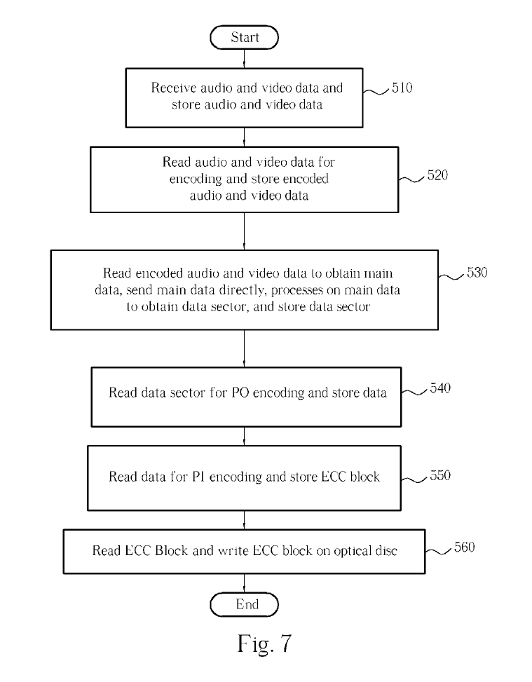

Please refer to FIG. 7 as well as FIG. 2. FIG. 7 shows a flowchart of the method for audio/video encoding according to the first embodiment of the present invention as follows:

Step510: Receive audio and video data by the audio/video codec circuit 240 and store them into the memory 260.

Step520: Read the audio and the video data from the memory 260 by the audio/video codec circuit 240, perform audio/video encoding and store the encoded audio and video data back into the memory 260.

Step530: Read the encoded audio and video data from the memory 260 by the audio/video codec circuit 240, multiplex the audio and video bit streams and add in navigation data to obtain at least one piece of main data to transmit directly to the optical storage read/write controller circuit 220, and perform EDC encoding and scrambling to the main data by the optical storage read/write controller circuit 220 to obtain at least one data sector and store the data sectors back into the memory 260.

Step540: Read the data sectors from the memory 260 by the optical storage read/write controller circuit 220; perform PO encoding and store the result back into the memory 260.

Step550: Read the data sectors from the memory 260 by the optical storage read/write controller circuit 220, perform PI encoding to obtain an ECC block, and store the ECC block into the memory 260.

Step560: Read the ECC block from the memory 260 by the optical storage read/write controller circuit 220 and control the disk loader mechanism 210 to write the ECC block on the optical disk.

The person skilled in the art can easily find that the number of times the memory 260 is accessed is less than that in the related art. Especially in the case of Step 530, the related art would require the memory to be accessed many times to accomplish the same goal (for instance, in the related art, first read the encoded audio and video data from the memory 160 by the audio/video codec circuit 140, multiplex the audio and video bit streams, and add in the navigation data to obtain the main data and store the main data back to the memory 160. Then read the main data from the memory 160 to store the data into the memory 150 through the bus interface 126, the bus 130, and the bus interface 146. After that, read the main data from the memory 150 by the optical storage read/write controller circuit 120, perform EDC encoding and scrambling to the main data to obtain the data sectors, and store the data sectors into the memory 150). In contrast, the present invention only requires reading the data in the memory 260 in Step 530 and storing the data back into the memory 260 after processing, without any additional memory access. Therefore, the present invention reduces the requirement on memory bandwidth of the single chip electronic circuit 230. Since the number of memory accesses is reduced, the performance in encoding can be improved. Please notice that any two or more steps can be integrated into one signal step (for instance, PO encoding and PI encoding in Step 540 and Step 550 can be integrated into one single step), in order to further reduce the number of memory accesses.

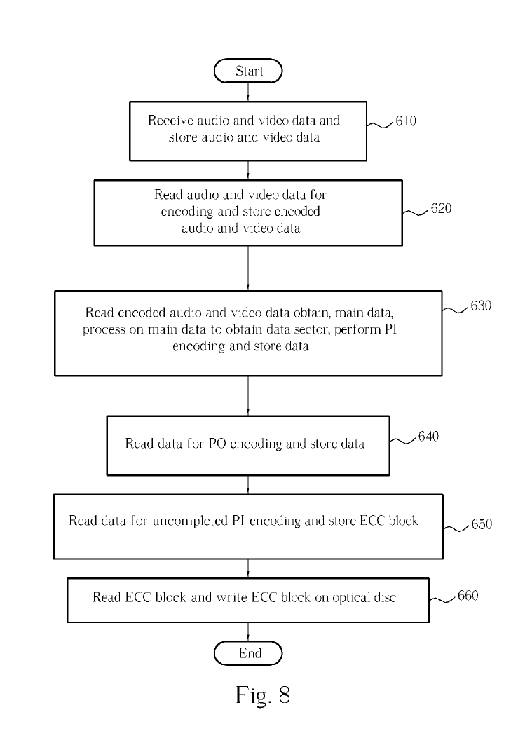

Please refer to FIG. 8 showing a flowchart of the method for audio/video encoding according to the second embodiment of the present invention as follows:

Step610: Receive audio and video data by the audio/video codec circuit 240 and store them into the memory 260.

Step620: Read the audio and the video data from the memory 260 by the audio/video codec circuit 240; perform audio/video encoding and store the encoded audio and video data back into the memory 260.

Step630: Read the encoded audio and video data from the memory 260 by the audio/video codec circuit 240, multiplex the audio and video bit streams and add in navigation data to obtain at least one piece of main data and transmit directly to the optical storage read/write controller circuit 220, and perform EDC encoding and scrambling to the main data by the optical storage read/write controller circuit 220 to obtain at least one data sector, and then perform PI encoding to the data sectors and store the processed data into the memory 260.

Step640: Read the data from the memory 260 by the optical storage read/write controller circuit 220; perform PO encoding and store the processed data into the memory 260.

Step650: Read the data sectors from the memory 260 by the optical storage read/write controller circuit 220, perform PI encoding uncompleted in Step630 to obtain an ECC block, and store the ECC block into the memory 260.

Step660: Read the ECC block from the memory 260 by the optical storage read/write controller circuit 220 and control the disk loader mechanism 210 to write the ECC block on the optical disk.

The method in FIG. 8 has the same advantages as the method in FIG. 7. The main technical feature of FIG. 8 is that during ECC encoding, the related art performs PO encoding (i.e. perform PO operation on 16 data sectors to obtain PO code) in advance of PI encoding (i.e. perform PI operation on both the 16 data sectors and PO code to obtain PI code), while the second embodiment of the present invention performs PI encoding (i.e. perform PI operation on the 16 data sectors to obtain PI code) in Step630, and then performs PO encoding (i.e. perform PO operation on 16 data sectors to obtain PO code) in Step640, and then performs PI encoding uncompleted in Step630 (i.e. perform PI operation on PO code to obtain remaining PI). In the present embodiment, since more work is integrated in Step630, the number of memory accesses can be further reduced. Therefore, compared by the encoding method according to the first embodiment, the encoding method according to the second embodiment further reduces the requirement on memory bandwidth of the single chip electronic circuit 230 and hence, improves the performance of the whole system. Moreover, please notice that by further combining Step640 and Step650 into one step, the number of memory accesses can be further reduced.

In contrast to the related art, the methods according to the present invention can not only reduce the number of memory access of the single chip electronic circuit, but also improve the performance of the whole system, while encoding or decoding.

Those skilled in the art will readily observe that numerous modifications and alterations of the device and method may be made while retaining the teachings of the invention. Accordingly, the above disclosure should be construed as limited only by the metes and bounds of the appended claims.

1. A method for audio/video decoding using a single chip electronic circuit, the single chip electronic circuit comprising:
an optical storage read controller circuit; and
an audio/video decoding circuit using the same memory as the optical storage read controller circuit, the method comprising:
(a) controlling the read operation of an error correction code (ECC) block from an optical disk by the optical storage read controller circuit, processing the ECC block to obtain at least one data sector, and storing the data sector into the memory;
(b) reading the data sector from the memory by the optical storage read controller circuit to obtain at least one piece of main data, transmitting the main data to the audio/video decoding circuit directly, separating the main data into audio and video streams by the audio/video decoding circuit and storing the separated audio and video data into the memory; and
(c) reading the separated audio and video data from the memory by the audio/video decoding circuit to perform audio/video decoding and storing the decoded audio and video data into the memory.

2. The method of claim 1 wherein Step (a) further comprises:
controlling the read operation of the ECC block from the optical disk by the optical storage read controller circuit and storing the ECC block into the memory;
reading the ECC block from the memory by the optical storage read controller circuit, performing inner-code parity (PI) decoding, and storing a processed data into the memory; and
reading the processed data from the memory by the optical storage read controller circuit, performing outer-code parity (PO) decoding to obtain the data sector, and storing the data sector into the memory.

3. The method of claim 1 wherein Step (a) further comprises:
controlling the read operation of the ECC block from the optical disk by the optical storage read controller circuit and storing the ECC block into the memory;
reading the ECC block from the memory by the optical storage read controller circuit, performing inner-code parity (PI) decoding, and then performing outer-code parity (PO) decoding to obtain the data sector, storing the data sector into the memory.

4. The method of claim 1 wherein in Step (b), the optical storage read controller circuit descrambles the data sector and performs error detection of the data sector by using an error-detection code (EDC) to obtain the main data.

5. The method of claim 1 further comprising:
(d) reading the decoded audio and video data from the memory by the audio/video decoding circuit and transmitting them respectively to a display device and a sound device.

6. A method for audio/video decoding using a single chip electronic circuit, the single chip electronic circuit comprising:
an optical storage read controller circuit; and
an audio/video decoding circuit using the same memory as the optical storage read controller circuit, the method comprising:
(a) controlling the read operation of an ECC block from an optical disk by the optical storage read controller circuit, performing PO decoding to the ECC block, and storing a processed data into the memory;
(b) reading the processed data from the memory by the optical storage read controller circuit, performing PI decoding to obtain at least one data sector, processing the data sector to obtain at least one piece of main data and transmitting the main data to the audio/video decoding circuit directly, and separating the main data into audio and video streams by the audio/video decoding circuit and storing the separated audio and video data into the memory; and
(c) reading the separated audio and video data from the memory by the audio/video decoding circuit to perform audio/video decoding and storing the decoded audio and video data into the memory.

7. The method of claim 6 wherein Step (a) further comprises:
controlling the read operation of the ECC block from the optical disk by the optical storage read controller circuit and storing the ECC block into the memory; and
reading the ECC block from the memory by the optical storage read controller circuit, performing PI decoding, and storing the processed data into the memory.

8. The method of claim 6 wherein in Step (b), the optical storage read controller circuit descrambles the data sector and performs error detection of the data sector by using an EDC data to obtain the main data.

9. The method of claim 6 further comprising:
(e) reading the decoded audio and video data from the memory by the audio/video decoding circuit and transmitting them respectively to a display device and a sound device.

10. A method for audio/video encoding using a single chip electronic circuit, the single chip electronic circuit comprising:
an optical storage write controller circuit; and
an audio/video encoding circuit using the same memory as the optical storage write controller circuit, the method comprising:
(a) receiving an audio and video data by the audio/video encoding circuit to perform audio/video encoding and storing an encoded audio and video data into the memory;
(b) reading the encoded audio and video data from the memory by the audio/video encoding circuit to multiplex the encoded audio and video data in order to obtain at least one piece of main data, transmitting the main data to the optical storage write controller circuit directly, processing the main data by the optical storage write controller circuit to obtain at least one data sector, and storing the data sector into the memory; and
(c) reading the data sector from the memory by the optical storage write controller circuit, processing the data sector to obtain an ECC block, and writing the ECC block in an optical disk.

11. The method of claim 10 wherein Step (a) further comprises:
receiving the audio and video data by the audio/video encoding circuit and storing the audio and video data into the memory; and
reading the audio and video data from the memory by the audio/video encoding circuit for audio/video encoding and storing the encoded audio and video data into the memory.

12. The method of claim 10 wherein in Step (b), the optical storage write controller circuit performs the error-detection code (EDC) encoding and scramble operation of at least one piece of the main data to obtain at least one data sector.

13. The method of claim 10 wherein in Step (b), the audio/video encoding circuit adds a navigation data to the main data while multiplexing the audio and video bit streams.

14. The method of claim 10 wherein Step (c) further comprises:
reading the data sector from the memory by the optical storage write controller circuit, processing PO encoding, and then storing a processed data into the memory;
reading the processed data from the memory by the optical storage write controller circuit, processing PI encoding to obtain the ECC block, and then storing the ECC block into the memory; and
reading the ECC block from the memory by the optical storage write controller circuit and writing the ECC block into the optical disk.

15. The method of claim 10 wherein Step (c) further comprises:
reading the data sector from the memory by the optical storage write controller circuit, processing PO encoding, and then processing PI encoding to obtain the ECC block and storing the ECC block into the memory; and
reading the ECC block from the memory by the optical storage write controller circuit and writing the ECC block into the optical disk.

16. A method for audio/video encoding using a single chip electronic circuit, the single chip electronic circuit comprising:
an optical storage write controller circuit; and
an audio/video encoding circuit using the same memory as the optical storage write controller circuit, the method comprising:
(a) receiving an audio and video data by the audio/video encoding circuit to perform audio/video encoding and storing an encoded audio and video data into the memory;
(b) reading the encoded audio and video data from the memory by the audio/video encoding circuit to multiplex the encoded audio and video data in order to obtain at least one piece of main data, transmitting the main data to the optical storage write controller circuit directly, processing the main data by the optical storage write controller circuit to obtain at least one data sector, performing PI encoding to the data sector, and storing a processed data into the memory; and
(c) reading the processed data from the memory by the optical storage write controller circuit, performing uncompleted ECC encoding to obtain an ECC block, and writing the ECC block in an optical disk.

17. The method of claim 16 wherein Step (a) further comprises:
receiving the audio and video data by the audio/video encoding circuit and storing the audio and video data into the memory;
reading the audio and video data from the memory by the audio/video encoding circuit, operating audio/video encoding, and then storing the encoded audio and video data into the memory.

18. The method of claim 16 wherein in Step (b), the optical storage write controller circuit performs the error-detection code (EDC) encoding and scramble operation of the at least one piece of the main data to obtain the at least one data sector.

19. The method of claim 16 wherein in Step (b), the audio/video encoding circuit adds a navigation data to the main data while multiplexing the audio and video bit streams.

20. The method of claim 16 wherein Step (c) further comprises:
reading the data from the memory by the optical storage write controller circuit, processing PO encoding, and storing a processed data into the memory;
reading the processed data from the memory by the optical storage write controller circuit, processing PI encoding uncompleted in Step (b) in order to obtain the ECC block, and storing the ECC block into the memory; and
reading the ECC block from the memory by the optical storage write controller circuit, and writing the ECC block into the optical disk.

21. The method of claim 16 wherein Step (c) further comprises:
reading the data from the memory by the optical storage write controller circuit, processing PO encoding, and then processing PI encoding uncompleted in Step (b) in order to obtain the ECC block and storing the ECC block into the memory; and
reading the ECC block from the memory by the optical storage write controller circuit and writing the ECC block into the optical disk.
